(19) United States
(12) Patent Application Publication
(10) Pub. No.: US 2005/0200226 A1
(43) Pub. Date: Sep. 15, 2005

(54) Method for manufacturing stator of brushless direct current electric motor, and stator of brushless direct current electric motor manufactured by the method

(75) Inventors: Young-Kwan Kim, Gyeonggi-Do (KR); Byung-Taek Kim, Gyeonggi-Do (KR); Jang-Ho Shim, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/011,436

(22) Filed: Dec. 15, 2004

(30) Foreign Application Priority Data
Mar. 9, 2004 (KR) 15924/2004

(51) Int. Cl. H02K 21/12; H02K 1/18

(52) U.S. Cl. 310/218; 310/259

(57) ABSTRACT

Disclosed is a method for manufacturing a stator of a brushless direct current electric motor which can cut down the unit cost of production and improve the B-H property and the core loss property, by forming a band-shaped back yoke by using a silicon steel plate sheet, helically stacking the back yoke, and inserting poles formed by a magnetic iron powder into the inner circumferential surface of the back yoke, and a stator of a brushless direct current electric motor manufactured by the method.

### BACKGROUND OF THE INVENTION

1. Field of the Invention

The present invention relates to a method for manufacturing a stator of a brushless direct current electric motor, and a stator of a brushless direct current electric motor manufactured by the method, and more particularly to, a method for manufacturing a stator of a brushless direct current electric motor which can improve the B-H property and the core loss property by helically stacking a back yoke made of a silicon steel plate sheet, and inserting poles formed by a magnetic iron powder into the inner circumferential surface of the back yoke, and a stator of a brushless direct current electric motor manufactured by the method.

2. Description of the Background Art

In general, a brushless direct current electric motor does not include a commutator, and has one of a rotor and a stator connected to a power supply and the other one operated by induction.

FIG. 1 is a vertical-sectional diagram illustrating a conventional brushless direct current electric motor made of a silicon steel plate sheet, and FIG. 2 is a plane diagram illustrating a stator of the conventional brushless direct current electric motor made of the silicon steel plate sheet.

Referring to FIGS. 1 and 2, in the conventional brushless direct current electric motor made of the silicon steel plate sheet, a stator 20 is installed along the inner circumferential surface of an electric motor main body 10 serving as a casing, and a rotor 30 is rotatably installed on a rotary axis 40 at the center of the stator 20.

The stator 20 has a stacked structure of a plurality of silicon steel plate sheets. A back yoke 21 is formed on the outer circumferential surface of the stator 20, and a plurality of poles 22 are formed on the inner circumferential surface of the back yoke 21 at predetermined intervals.

The back yoke 21 and the poles 22 of the stator 20 are formed according to a press punching process which has been publicly known.

A plurality of slots 23 are formed between the poles 22 at predetermined intervals, insulating papers 25 cover the outer circumferential surfaces of each pole 22 and the inner circumferential surface of the back yoke 21, and coils 24 are coiled around the outer circumferential surfaces of the poles 22.

The operation of the conventional brushless direct current electric motor made of the silicon steel plate sheet will now be explained.

When power is applied to the coils 24, a rotating magnetic field (range of magnetic field rotating the rotor) is generated by a current flowing through the coils 24, and an induced current is generated on the rotor 30.

A rotating torque is generated on the rotor 30 by the interactions between the rotating magnetic field and the induced current, to rotate the rotor 30 and the rotary axis 40.

In the stator 20 of the conventional brushless direct current electric motor made of the silicon steel plate sheet, the back yoke 21 and the poles 22 are formed by pressing and punching the silicon steel plate sheet. Therefore, a lot of scraps are formed in the punching process after forming the back yoke 21 and the poles 22. That is, a material (silicon steel plate sheet) is unnecessarily wasted.

In order to solve the foregoing problem, a powder metallurgy process for manufacturing a target component by putting a magnetic iron powder in a mold and sintering the magnetic iron powder has been suggested.

FIG. 3 is a plane diagram illustrating a stator of a conventional brushless direct current electric motor formed by a magnetic iron powder.

As shown in FIG. 3, in the stator 50 of the conventional brushless direct current electric motor formed by the magnetic iron powder, a back yoke 51 is formed on the outer circumferential surface of the stator 50, and a plurality of poles 52 are formed on the inner circumferential surface of the back yoke 51 at regular intervals.

In the case of the stator 50 formed by the magnetic iron powder, the back yoke 51 and the poles 52 can be formed in wanted shapes, and a volume of coils 53 coiled around the outer circumferential surfaces of the poles 52 can be reduced. However, as compared with the stator 20 made of the silicon steel plate sheet of FIG. 2, the stator 50 formed by the magnetic iron powder deteriorates the B-H property and the core loss property.

The B-H property and the core loss property of the silicon steel plate sheet and the magnetic iron powder will now be explained with reference to FIGS. 4 and 5.

FIG. 4 is a graph showing the B-H property.

As depicted in FIG. 4, a traverse axis shows an electric field H, an ordinates axis shows a flux density B, a curved line 1 shows a silicon steel plate sheet, and a curved line 2 shows a magnetic iron powder.

In an electric field section ranging from 10000 to 20000, the curved line 2 is relatively smaller in flux density B than the curved line 1.

That is, the electric field is proportional to the current and the flux density is proportional to the output. Accordingly, when the same current is applied, the output from the electric motor using the stator formed by the magnetic iron powder is relatively lower than the output from the electric motor using the stator made of the silicon steel plate sheet.

FIG. 5 is a graph showing the core loss property.

As illustrated in FIG. 5, a traverse axis shows a flux density B, an ordinates axis shows a core loss, a curved line 1 shows a silicon steel plate sheet, and a curved line 2 shows a magnetic iron powder. In the whole flux density section, the curved line 2 is relatively higher than the curved line 1.

In consideration of the B-H property and the core loss property, it is recognized that the output from the electric motor using the stator formed by the magnetic iron powder is relatively lower than the output from the electric motor using the stator made of the silicon steel plate sheet.

As described above, the conventional brushless direct current electric motor made of the silicon steel plate sheet shows more excellent B-H property and core loss property than the conventional brushless direct current electric motor formed by the magnetic iron powder, but generates a large number of scraps, which results in a large loss of the silicon steel plate sheet.

On the other hand, the conventional brushless direct current electric motor formed by the magnetic iron powder does not generate scraps, but more deteriorates the B-H property and core loss property than the conventional brushless direct current electric motor made of the silicon steel plate sheet, which results in low output and efficiency.

### SUMMARY OF THE INVENTION

Therefore, an object of the present invention is to provide a method for manufacturing a stator of a brushless direct current electric motor which can cut down the unit cost of production and improve the B-H property and the core loss property, by forming a band-shaped back yoke by using a silicon steel plate sheet, helically stacking the back yoke, and inserting poles formed by a magnetic iron powder into the inner circumferential surface of the back yoke, and a stator of a brushless direct current electric motor manufactured by the method.

To achieve these and other advantages and in accordance with the purpose of the present invention, as embodied and broadly described herein, there is provided a method for manufacturing a stator of a brushless direct current electric motor which takes advantages of a press process and a powder metallurgy process by forming a back yoke of the stator according to the press process, forming poles of the stator according to the powder metallurgy process, and assembling the back yoke and the poles into the stator, the method including the steps of: forming a band-shaped back yoke material by punching a silicon steel plate sheet; forming a back yoke of the stator by helically stacking the back yoke material; forming poles of the stator by forming and sintering a magnetic iron powder; coupling the poles to the back yoke by inserting the poles into the inner circumferential surface of the back yoke; covering the poles with insulating papers; and coiling coils around the outer circumferential surfaces of the poles covered with the insulating papers.

According to one aspect of the present invention, a stator manufactured by a method for manufacturing a stator of a brushless direct current electric motor includes: a back yoke formed by helically stacking a band-shaped silicon steel plate sheet; poles inserted into coupling grooves formed on the inner circumferential surface of the back yoke at regular intervals; and coils coiled around the outer circumferential surfaces of the poles covered with insulating papers.

According to another aspect of the present invention, a method for manufacturing a brushless direct current electric motor includes the steps of: forming a band-shaped back yoke material by punching a silicon steel plate sheet; forming a back yoke of the stator by helically stacking the back yoke material; forming poles by using a magnetic iron powder; coiling coils around bobbins; inserting the bobbins onto the outer circumferential surfaces of the poles; and coupling the poles to the back yoke by inserting the poles into the inner circumferential surface of the back yoke.

According to yet another aspect of the present invention, a stator manufactured by a method for manufacturing a stator of a brushless direct current electric motor includes: a back yoke formed by helically stacking a band-shaped silicon steel plate sheet; poles inserted onto coupling protrusions formed on the inner circumferential surface of the back yoke at regular intervals; bobbins inserted onto the outer circumferential surfaces of the poles; and coils coiled around the outer circumferential surfaces of the bobbins.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a vertical-sectional diagram illustrating a conventional brushless direct current electric motor made of a silicon steel plate sheet;

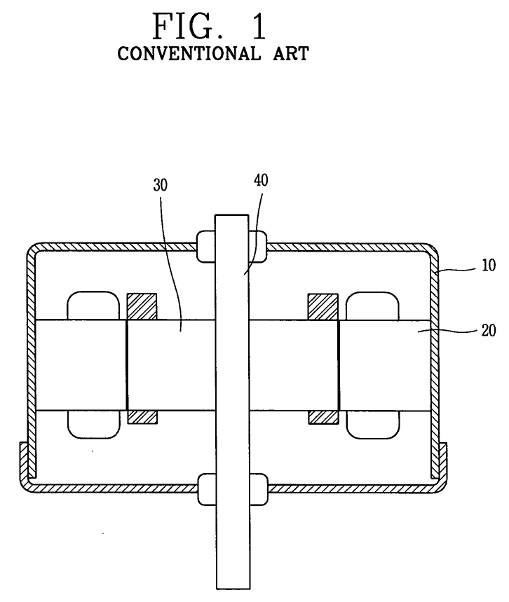

FIG. 2 is a plane diagram illustrating a stator of the conventional brushless direct current electric motor made of the silicon steel plate sheet;

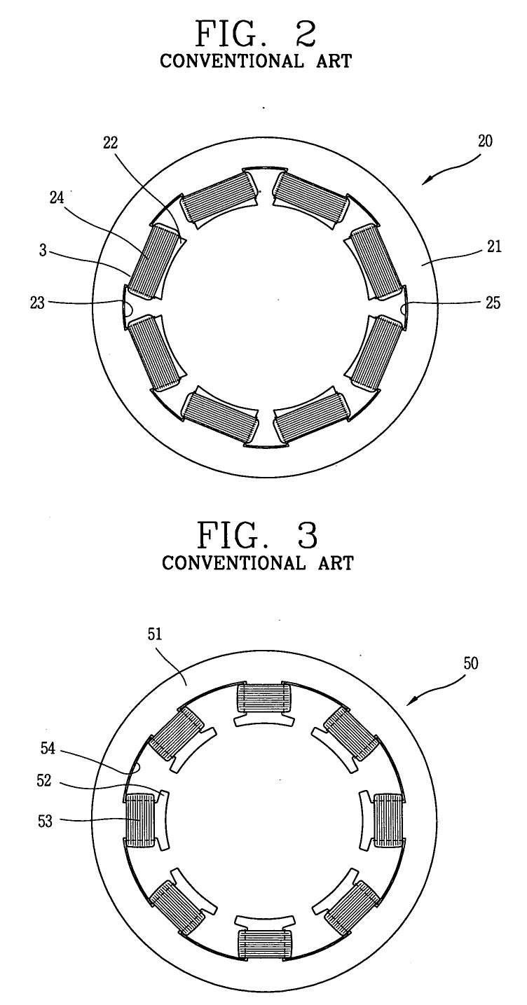

FIG. 3 is a plane diagram illustrating a stator of a conventional brushless direct current electric motor formed by a magnetic iron powder.

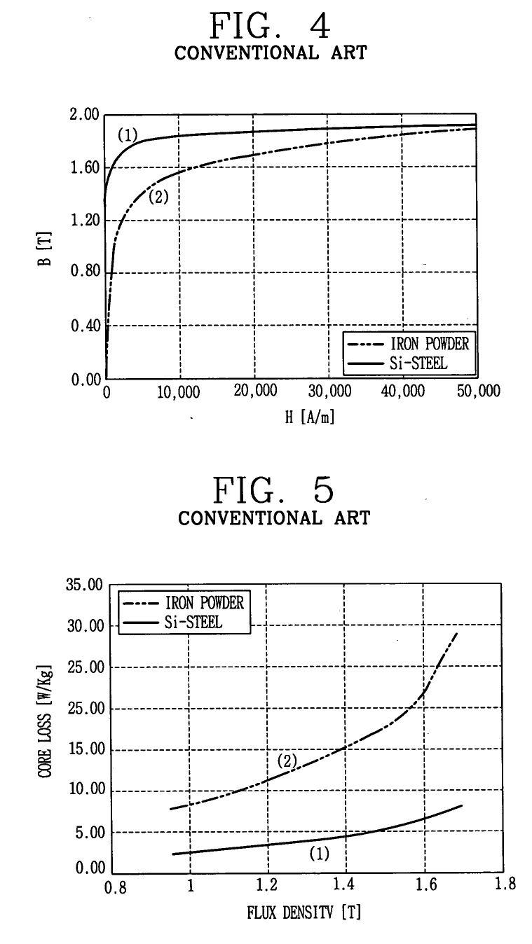

FIG. 4 is a graph showing the B-H property;

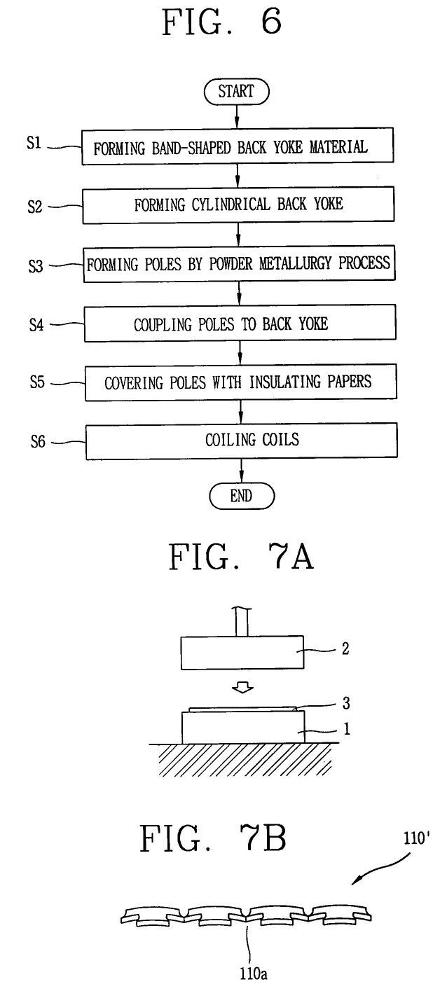

FIG. 5 is a graph showing the core loss property;

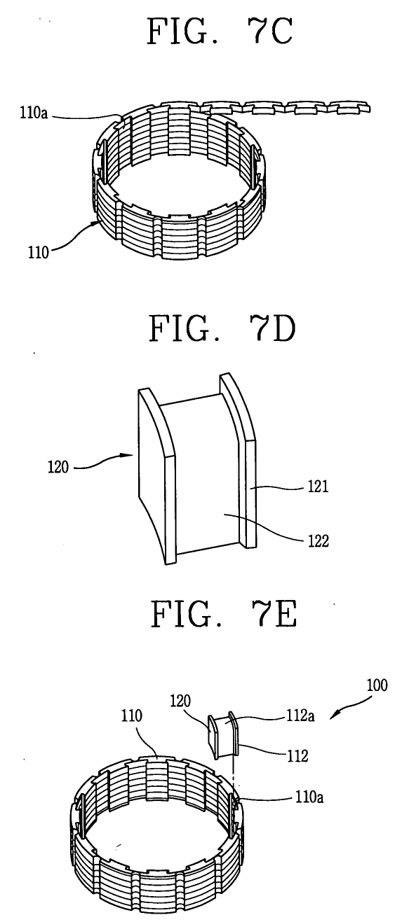

FIG. 6 is a flowchart showing sequential steps of a process for manufacturing a stator of a brushless direct current electric motor in accordance with a first embodiment of the present invention;

FIGS. 7A to 7G are diagrams illustrating the process for manufacturing the stator of the brushless direct current electric motor in accordance with the first embodiment of the present invention;

FIG. 8 is a plane diagram illustrating the stator manufactured by the method for manufacturing the stator of the brushless direct current electric motor in accordance with the first embodiment of the present invention;

FIG. 9 is a flowchart showing sequential steps of a process for manufacturing a stator of a brushless direct current electric motor in accordance with a second embodiment of the present invention;

FIGS. 10A to 10G are diagrams illustrating the process for manufacturing the stator of the brushless direct current electric motor in accordance with the second embodiment of the present invention; and

FIG. 11 is a plane diagram illustrating the stator manufactured by the method for manufacturing the stator of the brushless direct current electric motor in accordance with the second embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

A brushless direct current electric motor in accordance with the preferred embodiments of the present invention will now be described in detail with reference to the accompanying drawings.

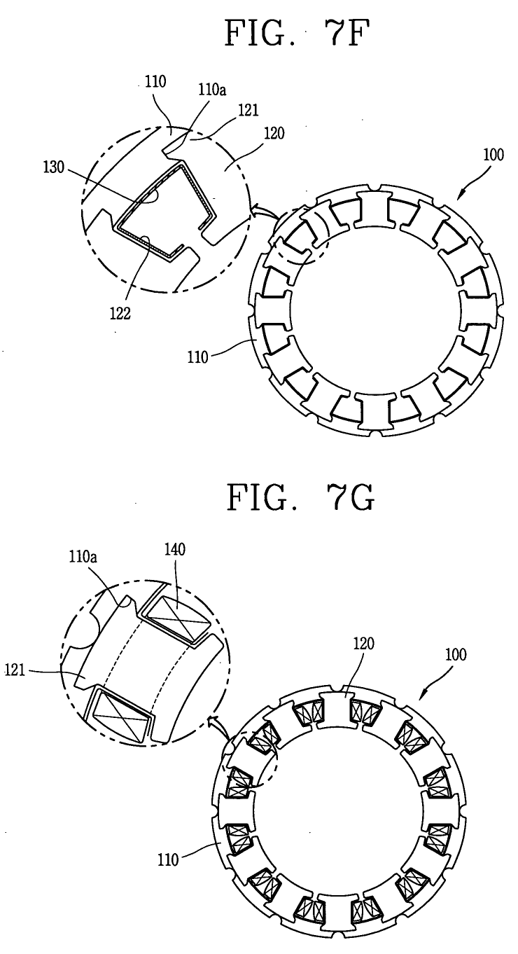

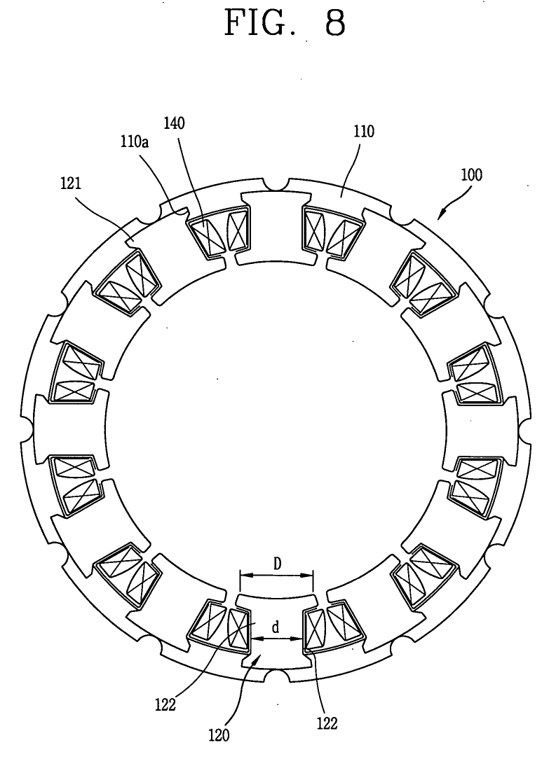

FIG. 6 is a flowchart showing sequential steps of a process for manufacturing a stator of a brushless direct current electric motor in accordance with a first embodiment of the present invention, and FIGS. 7A to 7G are diagrams illustrating the process for manufacturing the stator of the brushless direct current electric motor in accordance with the first embodiment of the present invention.

Referring to FIG. 6, in accordance with the first embodiment of the present invention, the method for manufacturing the stator of the brushless direct current electric motor includes the steps of forming a band-shaped back yoke material by punching a silicon steel plate sheet (S1), forming a back yoke of the stator by helically stacking the back yoke material (S2), forming poles of the stator by using a magnetic iron powder (S3), coupling the poles to the back yoke by inserting the poles into the inner circumferential surface of the back yoke (S4), covering the inner circumferential surface of the back yoke and the outer circumferential surfaces of the poles with insulating papers (S5), and coiling coils around the outer circumferential surfaces of the poles covered with the insulating papers (S6).

As shown in FIG. 7A, in the step for forming the back yoke material, a band-shaped back yoke material 110′ is formed by pressing and punching a silicon steel plate sheet 3 positioned on a base mold 1 by a movable mold 2. As depicted in FIG. 7B, coupling grooves 110a are formed on one side surface of the back yoke material 110′ at regular intervals.

As illustrated in FIG. 7C, in the step for forming the back yoke, a cylindrical back yoke 110 is formed by helically stacking the back yoke material 110′ of FIG. 7B. Here, the coupling grooves 110a are positioned on the inner circumferential surface of the back yoke 110.

Referring to FIG. 7D, in the step for forming the poles, a plurality of poles 120 are formed according to a powder metallurgy process. That is, the plurality of poles 120 are formed by putting a magnetic iron powder in a pole-shaped mold (not shown) and sintering the magnetic iron powder.

In each of the poles 120, a coupling protrusion 121 is formed at one side end of the pole 120, and a rounding unit 122 is formed on the outer circumferential surface of the middle part of the pole 120.

As shown in FIG. 7E, in the step for coupling the poles to the back yoke, the coupling protrusions 121 of the poles 120 are inserted into the coupling grooves 110a formed on the inside surface of the back yoke 110, so that the poles 120 can be coupled to the back yoke 110.

As illustrated in FIG. 7F, in the step for covering the poles with the insulating papers, insulating papers 130 cover the outer circumferential surfaces of the poles 120, namely, the rounding units 122 and the inner circumferential surface of the back yoke 110 to prevent coils 140 discussed later from directly contacting the poles 120 and the back yoke 110.

As depicted in FIG. 7G, in the step for coiling the coils around the outer circumferential surfaces of the poles covered with the insulating papers, the coils 140 are coiled around the outer circumferential surfaces of the poles 120 according to a general method. Thus, the process for manufacturing the stator 100 is finished.

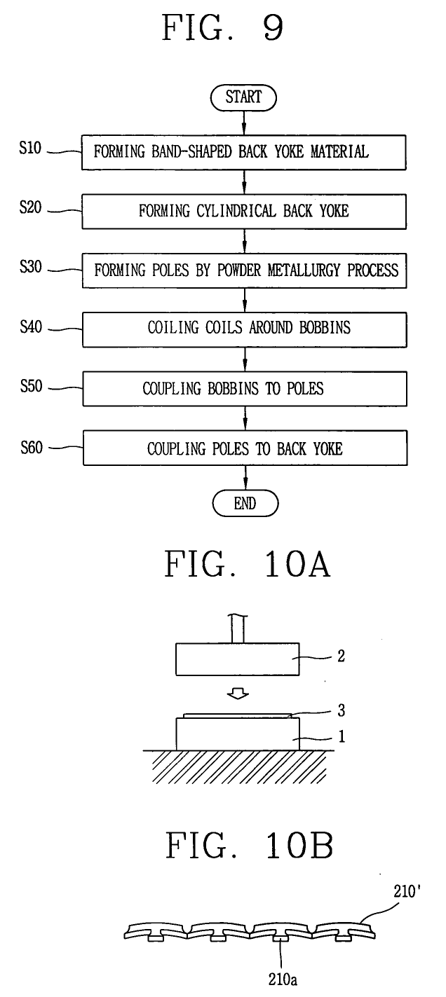

FIG. 8 is a plane diagram illustrating the stator manufactured by the method for manufacturing the stator of the brushless direct current electric motor in accordance with the first embodiment of the present invention.

As illustrated in FIG. 8, in the stator 100 manufactured by the method for manufacturing the stator of the brushless direct current electric motor, the cylindrical back yoke 110 is formed by helically stacking the band-shaped silicon steel plate sheet, the coupling protrusions 121 of the poles 220 are inserted into the coupling grooves 110a formed on the inner circumferential surface of the back yoke 110 at regular intervals, the insulating papers 130 cover the outer circumferential surfaces of the poles 120 and the inner circumferential surface of the back yoke 110, and the coils 140 are coiled around the outer circumferential surfaces of the poles 120.

The rounding units 122 are formed on the outer circumferential surfaces of the poles 120. Here, a diameter (d) of the rounding unit 122 is relatively smaller than a diameter D of both ends, to reduce a volume of the coil 140 coiled around the rounding unit 122.

As described above, in accordance with the first embodiment of the present invention, in the stator 100 manufactured by the method for manufacturing the stator of the brushless direct current electric motor, the back yoke 110 is formed according to the press process, the poles 120 are formed according to the powder metallurgy process, and the poles 120 are coupled to the back yoke 110, thereby reducing scraps of the material and improving the B-H property and the core loss property.

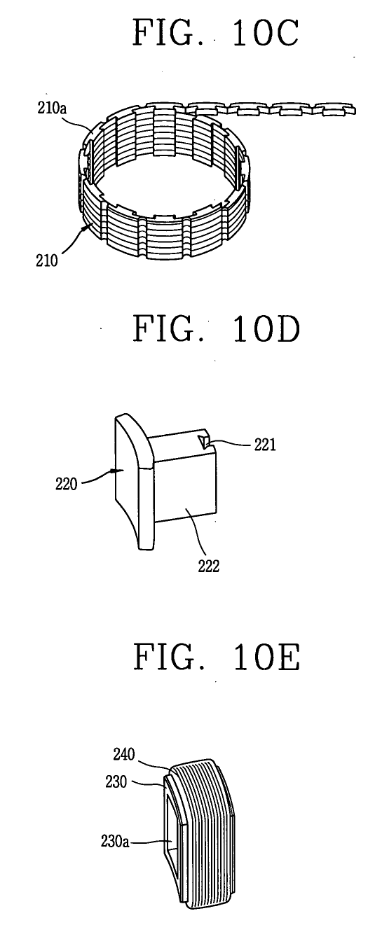

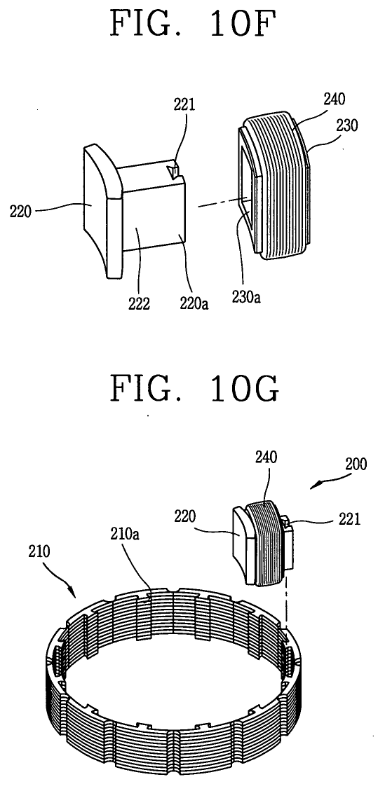

FIG. 9 is a flowchart showing sequential steps of a process for manufacturing a stator of a brushless direct current electric motor in accordance with a second embodiment of the present invention, and FIGS. 10A to 10G are diagrams illustrating the process for manufacturing the stator of the brushless direct current electric motor in accordance with the second embodiment of the present invention.

As shown in FIG. 9, in accordance with the second embodiment of the present invention, the method for manufacturing the stator of the brushless direct current electric motor includes the steps of forming a band-shaped back yoke material by punching a silicon steel plate sheet (S10), forming a back yoke of the stator by helically stacking the back yoke material (S20), forming poles by using a magnetic iron powder (S30), coiling coils around the outer circumferential surfaces of bobbins (S40), inserting the bobbins onto the poles (S50), and coupling the poles onto which the bobbins have been inserted to the back yoke (S60).

Referring to FIG. 10A, in the step for forming the back yoke material, a band-shaped back yoke material 210′ is formed by pressing and punching a silicon steel plate sheet 3 positioned on a base mold 1 by a movable mold 2. As depicted in FIG. 10B, coupling protrusions 210a are formed on one side surface of the back yoke material 210′ at regular intervals.

As illustrated in FIG. 10C, in the step for forming the back yoke, a cylindrical back yoke 210 is formed by helically stacking the band-shaped back yoke material 210′. Here, the coupling protrusions 210a are positioned on the inner circumferential surface of the back yoke 210.

As shown in FIG. 10D, in the step for forming the poles, a plurality of poles 220 are formed according to a powder metallurgy process of putting a magnetic iron powder in a pole-shaped mold (not shown) and sintering the magnetic iron powder.

In each of the poles 120, a coupling groove 221 into which the coupling protrusion 210a is inserted is formed at one side end of the pole 220, and a rounding unit 222 is formed on the outer circumferential surface of the middle part of the pole 220.

Referring to FIG. 10E, in the step for coiling the coils around the outer circumferential surfaces of the bobbins, coils 240 are coiled around tube-shaped bobbins 230 that can be inserted onto the poles 220 of FIG. 10D. Reference numeral 230a denotes an insertion hole.

As illustrated in FIG. 10F, in the step for inserting the bobbins onto the poles, the ends 220a of the poles 220 are inserted into the insertion holes 230a of the bobbins 230, so that the bobbins 230 can be coupled to the outer circumferential surfaces of the poles 220.

As depicted in FIG. 10G, in the step for coupling the poles onto which the bobbins have been inserted to the back yoke, the coupling protrusions 210a of the back yoke 210 are inserted into the coupling grooves 221 of the poles 220, so that the poles 220 can be coupled to the inner circumferential surface of the back yoke 210. Accordingly, the process for manufacturing the stator 200 is finished.

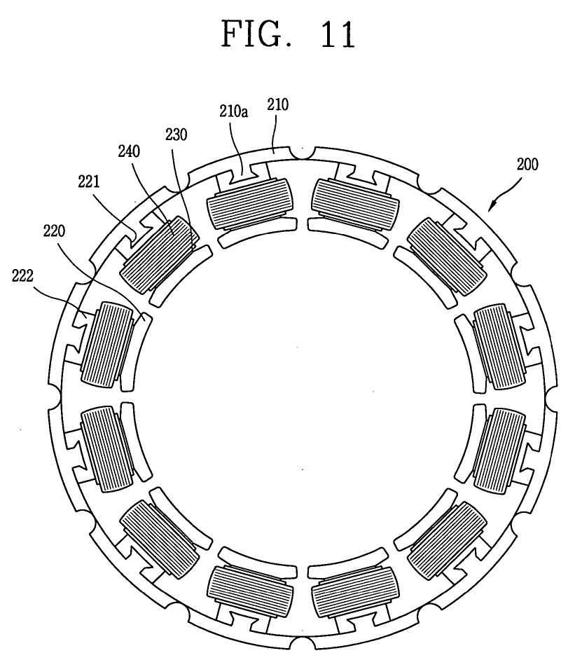

FIG. 11 is a plane diagram illustrating the stator of the brushless direct current electric motor in accordance with the second embodiment of the present invention.

As illustrated in FIG. 11, in the stator 200 of the brushless direct current electric motor, the back yoke 210 is formed by helically stacking the band-shaped silicon steel plate sheet, the poles 220 are inserted onto the coupling protrusions 210a formed on the inner circumferential surface of the back yoke 210 at regular intervals, the bobbins 230 are inserted onto the outer circumferential surfaces of the poles 220, and the coils 240 are coiled around the outer circumferential surfaces of the bobbins 230.

As discussed earlier, in accordance with the second embodiment of the present invention, the stator 200 of the brushless direct current electric motor can reduce scraps of the material and improve the B-H property and the core loss property.

Furthermore, the process for coiling the coils can be efficiently performed by using the bobbins, instead of using the insulating papers.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A method for manufacturing a stator of a brushless direct current electric motor, comprising the steps of:
forming a band-shaped back yoke material by punching a silicon steel plate sheet;
forming a back yoke of the stator by helically stacking the back yoke material;
forming poles by using a magnetic iron powder;
coupling the poles to the back yoke by inserting the poles into the inner circumferential surface of the back yoke;
covering the poles with insulating papers; and
coiling coils around the outer circumferential surfaces of the poles covered with the insulating papers.

2. The method of claim 1, wherein, in the step for forming the back yoke material, coupling grooves are formed inside the back yoke material at regular intervals, and in the step for forming the poles, coupling protrusions are formed at the ends of the poles to be inserted into the coupling grooves.

3. The method of claim 2, wherein, in the step for forming the poles, rounding units are formed on the outer circumferential surfaces of the poles.

4. The method of claim 3, wherein a diameter of the rounding unit of the pole is relatively smaller than that of both ends of the pole.

5. The method of claim 1, wherein, in the step for forming the back yoke, the back yoke is stacked in a cylindrical shape.

6. A method for manufacturing a stator of a brushless direct current electric motor, comprising the steps of:
forming a band-shaped back yoke material by punching a silicon steel plate sheet;
forming a back yoke of the stator by helically stacking the back yoke material;
forming poles by using a magnetic iron powder;
coiling coils around bobbins;
coupling the bobbins to the outer circumferential surfaces of the poles; and
coupling the poles to the back yoke by inserting the poles into the inside surface of the back yoke.

7. The method of claim 6, wherein, in the step for forming the back yoke material, coupling protrusions are formed inside the back yoke material at regular intervals, and in the step for forming the poles, coupling grooves are formed at the ends of the poles so that the coupling protrusions can be inserted into the coupling grooves.

8. The method of claim 6, wherein, in the step for forming the poles, rounding units are formed on the outer circumferential surfaces of the poles.

9. The method of claim 6, wherein a diameter of the rounding unit of the pole is relatively smaller than that of both ends of the pole.

10. A stator of a brushless direct current electric motor, comprising:
a back yoke formed by helically stacking a band-shaped silicon steel plate sheet;
poles inserted into coupling grooves formed on the inner circumferential surface of the back yoke at regular intervals; and
coils coiled around the outer circumferential surfaces of the poles covered with insulating papers.

11. The stator of claim 10, wherein the back yoke is stacked in a cylindrical shape.

12. A brushless direct current electric motor, comprising:
a back yoke formed by helically stacking a band-shaped silicon steel plate sheet;
poles inserted into coupling grooves formed on the inner circumferential surface of the back yoke at regular intervals;
bobbins inserted onto the outer circumferential surfaces of the poles; and
coils coiled around the outer circumferential surfaces of the bobbins.

13. The electric motor of claim 12, the back yoke is stacked in a cylindrical shape.
